(19) United States
(12) Patent Application Publication
(10) Pub. No.: US 2004/0107363 A1
(43) Pub. Date: Jun. 3, 2004

(54) SYSTEM AND METHOD FOR ANTICIPATING THE TRUSTWORTHINESS OF AN INTERNET SITE

(75) Inventor: Dante Monteverde, Barrington Hills, IL (US)

Correspondence Address: SEYFARTH SHAW, 55 EAST MONROE STREET, SUITE 4200, CHICAGO, IL, 60603-5803, US

(73) Assignee: EMERGENCY 24, INC., Chicago, IL (US)

(21) Appl. No.: 10/604,875

(22) Filed: Aug. 22, 2003

(51) Int. Cl. G06F 11/30; G06F 15/173

(52) U.S. Cl. 713/201; 713/175; 709/223

(57) ABSTRACT

A system and method for anticipating the trustworthiness of an Internet site having content comprising dynamically analyzing the content to assess the number of criteria the content complies with to create an analytical result and subsequently communicating to an Internet user the analytical result.

### BACKGROUND OF INVENTION

The present invention relates generally to methods for anticipating and displaying the trustworthiness of an Internet site. More particularly, the present invention relates to an Internet browser add-on capable of dynamically analyzing the content of an Internet site to create an analytical result designating the Internet site's anticipated trustworthiness.

The growth of the Internet has been compared to the period in American history known as the “gold rush.” Many entrepreneurs have decided to set up businesses in a virtual realm on the Internet with much of the same vigor as those Americans who decided to move out west in the hopes of striking gold. However, because it is not regulated and relies almost exclusively on private standardization and policing, many consumers find the Internet to be the digital equivalent of the Wild West that accompanied the “gold rush”. Consequently, numerous consumers have found themselves to be victims of online scams perpetrated by purportedly reputable Internet sites or had their identities stolen due to unscrupulous Internet sites posing as reputable retailers, subsequently leading to credit card fraud and the like. These Internet frauds have the further frustration of hindering essential consumer trust and Internet site reliability for continued growth of Internet related businesses and services.

To combat fraud, consumers may, for example, use various independent evaluators such as Consumer Reports®, the Better Business Bureau®, and others to obtain a summarized, and often underdeveloped, analysis about an online business or Internet site, but such a review is very limited in scope and reliability. Further, since the Internet site may change often, such reviews are quickly outdated. Thus, the time and effort it would take for a consumer to thoroughly research the reputability and trustworthiness of an Internet site prior to disclosing information to that site would be too cumbersome and unrealistic, and again hinder the Internet's growth.

To reduce unscrupulous Internet sites and to encourage the necessary trust consumers must have when they visit an unproven site, several organizations have programs that independently check and subsequently monitor an Internet site for several relevant trust related criteria. For example, TRUSTe® is an organization that checks respective privacy policies of Internet sites. When a Internet site's privacy policy has been approved by TRUSTe®, that Internet site is allowed to display the TRUSTe® Trustmark™ “seal of approval.” Accordingly, when a consumer sees the Trustmark™ seal on an Internet site, the consumer, recognizing the integrity of the TRUSTe® Trustmark™, feels a sense of comfort and security that his or her privacy and the information submitted to this Internet site will be protected without the need to conduct independent research on the Internet site nor analyze the complex privacy policy that is often laced with legalese. Many other organizations provide similar services for different venues, for example, retail reliability.

However, organizations certifying the reputability of an Internet site must manually approve the site, after the site submits a formal request for such approval, in order for the site to display that specific organization's “seal of approval.” The existing “seal of approval” methods also have an all-or-nothing standard, where the Internet site must adhere to all of the “seal of approval's” standards or it cannot display the seal at all. Also, since the Internet site owner must request the initiation of the approval process, only a small percentage of Internet sites participate in the “seal of approval” process. Further, compensation may be offered to the seal provider in order for an Internet site to display their seal, thereby compromising the seal providers” objectivity. Accordingly, there exists a need for a “seal of approval” method and system that does not require each Internet site to submit a request to be approved, that provides a scaled or gauged representation of the Internet site's trustworthiness based upon the number of criteria the Internet site adheres to, and that is unbiased by not expecting compensation.

Further, since the Internet site needs to display a “seal of approval”, which is simply an image file that can be easily pirated from another Internet site, there is the possibility that the “seal of approval” is fraudulently obtained, thus ultimately leading to a degradation in the “seal of approval's” consumer confidence. The only way to combat such a fraud problem is to ensure that only an independent third party has the capability of displaying the “seal of approval” outside of the control of the Internet site in question.

Moreover, there exists a need to provide an Internet user with an instantaneous trustworthiness scaled score, thus presenting a more detailed analytical result to the Internet user while allowing the user to make a more informed decision about disclosing information to the Internet site.

### SUMMARY OF INVENTION

In an embodiment, the present invention is a system and method for anticipating the trustworthiness of an Internet site having content. The method includes dynamically analyzing the content of the site to assess the number of criteria the content complies with in order to create an analytical result. The analytical request may then be communicated to an Internet user.

In another embodiment, the present invention includes an Internet browser add-on or plug-in capable of communicating to an Internet user the anticipated trustworthiness of an Internet site displayed in the Internet browser. The add-on may take the form of a tool bar integrated within the Internet browser. In an embodiment, the add-on provides the user with a trustworthiness representation, such as in the form of a scaled gauge or scaled numerical representation, that is communicated to the Internet user to convey the anticipated trustworthiness of an Internet site.

### BRIEF DESCRIPTION OF DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages, should be readily understood and appreciated.

FIG. 1 is an embodiment of the present invention incorporated into a typical Internet browser;

FIG. 2 is another embodiment of the present invention incorporated into a typical Internet browser; and

FIG. 3 is an example table of the criteria used by the present invention and the points assignable by each criterion to create the “trust score.”

### DETAILED DESCRIPTION

The present invention is a system and method for anticipating the trustworthiness of an Internet site having content. The method includes dynamically analyzing the content of an Internet site to assess or approximate the number or amount of criteria that the content complies with in order to create an analytical result. The analytical result may then be communicated to an Internet user. In an embodiment, the analytical result is communicated to an Internet user by displaying it. In another embodiment, the analytical result may be communicated to the Internet user by sound. It will be appreciated that other methods or forms of communicating the analytical result can be used without departing from the true scope and spirit of the present invention.

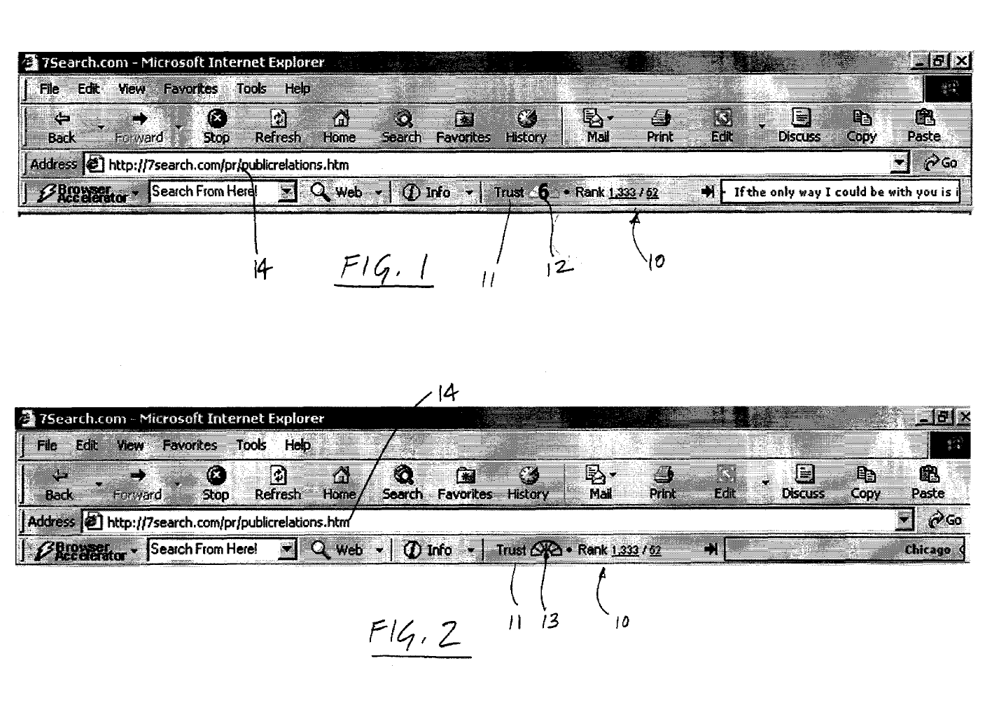

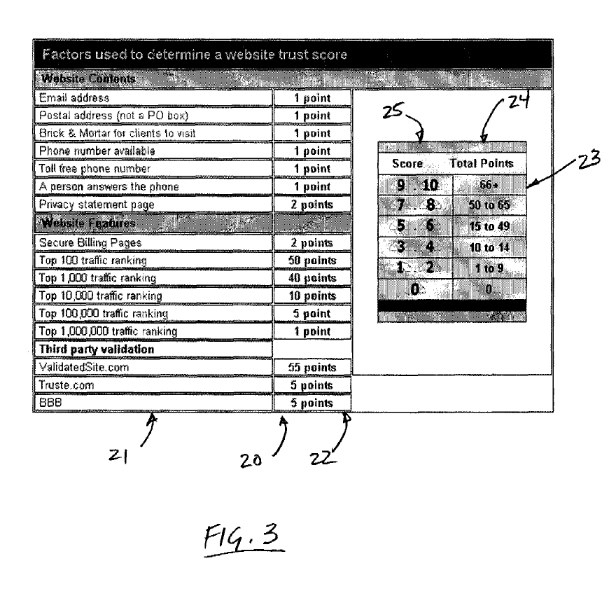

Referring to FIGS. 1 and 2, in an embodiment, the present invention includes an Internet browser add-on or plug-in 11 capable of communicating (e.g., visually, aurally, or tactilely) to an Internet user the anticipated trustworthiness of an Internet site displayed in the Internet browser 10. The add-on 11 preferably takes the form of a tool bar integrated within the Internet browser 10. The add-on 11 provides the user with a visual representation of the analytical result, such as in the form of a numerical representation 12 or scaled gauge 13, thereby communicating the anticipated trustworthiness of an Internet site. The add-on 11 also has the benefit of being independent of the Internet site, thus minimizing the possibility of manipulation or falsification of the trustworthiness representation by the Internet site operator.

The add-on 11 has the capability of dynamically reading and analyzing the content of a displayed Internet site in real-time. The content of the Internet site is subsequently read, analyzed and compared to a plurality of criteria in order to determine the number or amount of criteria that are met or adhered to by the content. In another embodiment, the add-on 11 has the capability to analyze an Internet site that is simply entered into an address field, where the Internet site's content is read and analyzed while not necessarily being displayed to the Internet user. Such an embodiment thus has the benefit of displaying an anticipated trustworthiness analytical result to the Internet user before the Internet user actually visits the Internet site.

Referring to FIG. 3, in an embodiment, each criterion 21 has a numerical point value 22 which is assigned or awarded to the Internet site if that criterion 21 is met. The point value 22 is based upon the criterion's 21 influence upon or relevance to the anticipated trustworthiness of the Internet site. For example, the more relevant or influential a criterion 21 is to determining an Internet site's trustworthiness, the greater the point value that the criterion 21 is capable of assigning to an Internet site. Accordingly, an analytical result in the form of a “trust score” can be determined by totaling the number of points that have been assigned to the Internet site, again based upon the number and kind of trustworthiness criteria that have been met. The “trust score” may thus represent a numerical representation of the anticipated trustworthiness of the Internet site. The “trust score” may also be scaled, for example, on a scale from 1 to 10. Accordingly, it will be appreciated that it is possible that two distinct Internet sites could receive the same “trust score” even though they are not symmetrical in terms of which criteria they have respectively met. It will further be appreciated that the figures represent examples of numerical point values for representative criteria and are being shown for exemplification purposes only and not to limit the true scope and sprit of the present invention.

In an embodiment, the “trust score” may subsequently be displayed to the Internet user in a numerical representation 12, either scaled or not. In another embodiment, the “trust score” can be displayed to the user in a scaled gauge representation 13. In yet another embodiment, both the gauge and numerical form may be used.

The plurality of criteria preferably respectively pertains or is relevant to anticipating the trustworthiness of an Internet site. For example, the criteria may include determining the existence of a privacy policy in the content of the Internet site; if the Internet site uses or supports secure Internet transactions, such as, for example, Secured Socket Layer (SSL) or other encryption technologies, to accept or transmit personal or otherwise confidential information; if the Internet site maintains a valid digital or other verified authentication certificate issued by a reputable certificate authority; the popularity or traffic ranking of the Internet site as assessed by the amount of traffic going to the Internet site; the presence of an email address in the content of the Internet site; the presence of a telephone number in the content of the Internet site; the presence of a postal address in the content of the Internet site; if the Internet site has been audited or otherwise validated by another validating service; or if the Internet site has a physical office for customers to visit. It will be appreciated that the criteria listed herein are for exemplification purposes only, whereas numerous other criteria can be utilized, and it is thus not intended to limit the true scope and spirit of the present invention.

In an embodiment, the add-on may search for one or more known criterion that previously have been met by the Internet site contained within a database provided by an independent party. For example, the add-on can search in a database to determine if an Internet site has a privacy policy or if such a privacy policy has been analyzed, thus negating the need to reanalyze the content of the Internet site for the privacy policy. Further, the add-on has the capability to verify if, for example, an Internet site's privacy policy has been changed since the last time the database information was updated.

It will be appreciated that the add-on may not be able to analyze if each criteria is met by the content of an Internet site, for example, determining if an office exists for the Internet user to visit. While this may affect the overall “trust score” given to the particular Internet site, in an embodiment, modified influence or relevancy may be given to criteria that can be analyzed by the add-on, thus compensating for the unknown or under-analyzed criteria.

In yet another embodiment, an Internet user can conduct a search for a particular type of Internet site using known search methodology, where a corresponding list of a plurality of Internet sites is displayed containing the respective “trust score” of the Internet sites by dynamically analyzing the content of each Internet site as described above. In another embodiment, an Internet user can include within the search methodology only Internet sites that meet a set “trust score”. Accordingly, the Internet user, can, for example, exclude Internet sites from being returned in the search results list that do not meet the desired minimum “trust score”.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants“contribution. The actual scope of the protection sought is intended to be defined in the following claims when viewed in their proper perspective based on the prior art.

1] A method of anticipating the trustworthiness of an Internet site having content comprising dynamically analyzing the content to assess an amount of criteria the content complies with thereby creating an analytical result and communicating to an Internet user the analytical result.

2] The method as claimed in claim 1 wherein the analytical result includes a numerical representation of the trustworthiness of the Internet site.

3] The method as claimed in claim 1 wherein the analytical result includes a scaled gauge representation of the trustworthiness of the Internet site.

4] The method as claimed in claim 2 wherein the criteria respectively includes numerical points wherein each criterion awards a number of points to the Internet site if the Internet site complies with the criterion.

5] The method as claimed in claim 4 wherein the numerical points each criterion can award is based upon the influence that the respective criteria has on the anticipated trustworthiness of the Internet site.

6] The method as claimed in claim 4 wherein the criteria includes determining if an electronic mail address is present in the content.

7] The method as claimed in claim 4 wherein the criteria includes determining if a postal address is present in the content.

8] The method as claimed in claim 4 wherein the criteria includes determining if a telephone number is present in the content.

9] The method as claimed in claim 4 wherein the criteria includes determining if privacy statement is present in the content.

10] The method as claimed in claim 4 wherein the criteria includes determining if the Internet site supports secure Internet transactions.

11] The method as claimed in claim 4 wherein the criteria includes determining if the Internet site has a verified authentication certificate.

12] The method as claimed in claim 4 wherein the criteria includes determining a popularity ranking of the Internet site.

13] The method as claimed in claim 4 wherein the criteria includes determining if the Internet site is validated by an independent third party validating service.

14] The method as claimed in claim 1 wherein the analytical result is communicated to the Internet user independently of the Internet site.

15] The method as claimed in claim 14 wherein the analytical result is displayed within a tool bar incorporated into an Internet browser.

16] A method of displaying the anticipated trustworthiness of an Internet site having content displayed in an Internet browser to an Internet user comprising:
providing an Internet browser add-on capable of communicating to the Internet user an analytical result representing the anticipated trustworthiness of the Internet site displayed in the Internet browser;
dynamically analyzing the content to assess the trustworthiness of the Internet site thereby defining the analytical result; and
communicating to the Internet user the analytical result.

17] The method as claimed in claim 16 wherein the analytical result includes a numerical representation of the anticipated trustworthiness of the Internet site.

18] The method as claimed in claim 16 wherein the step of dynamically analyzing the content to assess the trustworthiness of the Internet site thereby defining the analytical result includes determining an amount of criteria the content meets.

19] The method as claimed in claim 18 wherein the step of determining an amount of criteria the content meets includes a numerical point based system wherein each criterion awards a certain number of points to the amount if the Internet site complies with the criterion.

20] The method as claimed in claim 18 wherein the analytical result includes a scaled gauge representation of the trustworthiness of the Internet site.

21] The method as claimed in claim 18 wherein the criteria includes determining if an electronic mail address is present in the content.

22] The method as claimed in claim 18 wherein the criteria includes determining if a postal address is present in the content.

23] The method as claimed in claim 18 wherein the criteria includes determining if a telephone number is present in the content.

24] The method as claimed in claim 18 wherein the criteria includes determining if privacy statement is present in the content.

25] The method as claimed in claim 18 wherein the criteria includes determining if the Internet site supports secure Internet transactions.

26] The method as claimed in claim 18 wherein the criteria includes determining if the Internet site has a verified authentication certificate.

27] The method as claimed in claim 18 wherein the criteria includes determining a traffic ranking of the Internet site.

28] The method as claimed in claim 18 wherein the criteria includes determining if the Internet site is validated by an independent third party validating service.

29] A system for anticipating the trustworthiness of an Internet site having content displayed in an Internet browser comprising:
an Internet browser add-on capable of communicating to an Internet user an anticipated trustworthiness of the Internet site in a form of an analytical result; and
a means for dynamically analyzing the content to determine the anticipated trustworthiness of the Internet site to create the analytical result.

30] A method of anticipating the trustworthiness of an Internet site having content comprising dynamically analyzing the content to assess an amount of criteria the content complies with thereby creating an analytical result.

31] The method as claimed in claim 30 further comprising communicating to an Internet user the analytical result.

32] The method as claimed in claim 31 wherein the analytical result includes a numerical representation of the trustworthiness of the Internet site.

33] The method as claimed in claim 31 wherein the analytical result includes a scaled gauge representation of the trustworthiness of the Internet site.

34] The method as claimed in claim 31 wherein the criteria includes a numerical point system wherein each criterion awards a certain number of points to the Internet site if the Internet site complies with the criterion.

35] The method as claimed in claim 34 wherein the criteria includes determining if an electronic mail address is present in the content.

36] The method as claimed in claim 34 wherein the criteria includes determining if a postal address is present in the content.

37] The method as claimed in claim 34 wherein the criteria includes determining if a telephone number is present in the content.

38] The method as claimed in claim 34 wherein the criteria includes determining if privacy statement is present in the content.

39] The method as claimed in claim 34 wherein the criteria includes determining if the Internet site supports secure Internet transactions.

40] The method as claimed in claim 34 wherein the criteria includes determining if the Internet site has a verified authentication certificate.

41] The method as claimed in claim 34 wherein the criteria includes determining a traffic ranking of the Internet site.

42] The method as claimed in claim 34 wherein the criteria includes determining if the Internet site is validated by an independent third party validating service.

43] The method as claimed in claim 34 wherein the analytical result includes a numerical representation of the trustworthiness of the Internet site.

44] The method as claimed in claim 31 wherein the analytical result is communicated to the Internet user independently of the Internet site displayed.

45] The method as claimed in claim 44 wherein the analytical result is displayed within a tool bar incorporated into an Internet browser.
